(19) United States
(12) Patent Application Publication
(10) Pub. No.: US 2015/0036129 A1
(43) Pub. Date: Feb. 5, 2015

(54) INSPECTION APPARATUS

(71) Applicant: Genesis Photonics Inc., Tainan City (TW)

(72) Inventors: Cheng-Pin Chen, Tainan City (TW); Yun-Li Li, Taipei City (TW); Shou-Wen Hsu, Tainan City (TW); Chih-Hung Tseng, Tainan City (TW); Pei-Yi Huang, Tainan City (TW); Ching-Cheng Sun, Tainan City (TW); Tsung-Syun Huang, Tainan City (TW); Yung-Tsung Lin, Tainan City (TW); Ping-Tsung Tsai, Tainan City (TW)

(21) Appl. No.: 14/311,364

(22) Filed: Jun. 23, 2014

(30) Foreign Application Priority Data
Jul. 31, 2013 (TW) 102127517

(51) Int. Cl. G01N 21/01; G01N 21/95

(52) U.S. Cl. CPC G01N 21/01; G01N 21/9501
USPC 356/237.5

(57) ABSTRACT

An inspection apparatus is capable for inspecting at least one light-emitting device. The inspection apparatus includes a working machine and an inspection light source. The inspection light source is disposed on the working machine and located above the light-emitting device. A dominant wavelength of the inspection light source is smaller than a dominant wavelength of the light-emitting device so as to excite the light-emitting device and get an optical property of the light-emitting device.

### CROSS-REFERENCE TO RELATED APPLICATION

This application claims the priority benefit of Taiwan application serial no. 102127517, filed on Jul. 31, 2013. The entirety of the above-mentioned patent application is hereby incorporated by reference herein and made a part of this specification.

### BACKGROUND OF THE INVENTION

1. Field of the Invention

The present invention relates to an inspection apparatus. More particularly, the present invention relates to an inspection apparatus having an inspection light source.

2. Description of Related Art

In order to ensure a quality of a device of a manufactured light-emitting diode chip in a factory, a manufacturing process of the light-emitting diode chip includes lots of test procedures (for example, brightness test) so as to test whether the performance of the product can qualify a factory specification. As for the brightness test for example, a destructive probe may be utilize to respectively contact the anode and the cathode of the light-emitting diode chip so as to light up the light-emitting diode chip, and a property of the brightness is further acquired. However, since the destructive test method can merely test the brightness of one light-emitting diode chip at a time, lots of time and money is spent, and the damage of the structure of the light-emitting diode may be caused. Hence, how to effectively test the chip so as to reduce the cost of time has became an urgent problem to be solved for each and every industry in this field.

### SUMMARY OF THE INVENTION

The present invention provides an inspection apparatus capable of quickly inspecting whether a chip is abnormal or not.

The inspection apparatus of the present invention is capable of inspecting at least one light-emitting device. The inspection apparatus includes a working machine and an inspection light source. The inspection light source is disposed on the working machine and located above the light-emitting device. A dominant wavelength of the inspection light source is smaller than a dominant wavelength of the light-emitting device so as to excite the light-emitting device and get an optical property of the light-emitting device.

In one embodiment of the invention, the working machine includes a laser cutting machine, a point measurement machine, an auto optic inspection (AOI), a counter or a sorter.

In one embodiment of the present invention, the optical property includes a light intensity property and a luminous flux property.

In one embodiment of the present invention, the inspection apparatus further includes a light-collecting unit. The light-collecting unit is disposed above the light-emitting device so as to collect the optical property of the light-emitting device.

In one embodiment of the present invention, the inspection apparatus further includes a filter unit. The filter unit is disposed between the light-collecting unit and the inspection light source so as to filter out the light generated by the inspection light source.

In one embodiment of the present invention, the light-collecting unit includes a charge coupled device (CCD), an integral sphere, a solar panel or a photodetector array.

In one embodiment of the present invention, the inspection apparatus further includes a reflecting unit located on proximate horizontal position with the inspection light source and having a reflective surface. The reflective surface faces the inspection light source, wherein the reflective surface reflects the light generated by the inspection light source so as to make the light generated by the inspection light source emit into the light-emitting device.

In one embodiment of the present invention, the reflective surface and a normal line of the light-emitting device form an angle, and the angle is between 30 degrees and 60 degrees.

In one embodiment of the present invention, a difference between the dominant wavelength of the inspection light source and the dominant wavelength of the light-emitting device is at least greater than or equal to 20 nanometers.

In one embodiment of the present invention, the dominant wavelength of the inspection light source ranges between 320 nanometers and 400 nanometers.

In one embodiment of the present invention, a projection area of the light generated by the inspection light source on a horizontal projection plane overlaps a projection area of the light-emitting device on the horizontal projection plane.

In one embodiment of the present invention, the light-emitting device includes at least one light-emitting diode (LED) chip.

In one embodiment of the present invention, the inspection apparatus further includes a focusing unit disposed between the inspection light source and the light-emitting devise so as to focus the light generated by the inspection light source.

In one embodiment of the present invention, a minimal vertical distance between the inspection light source and the focusing unit is greater than or equal to a focal length of the focusing unit.

In view of the above, since the dominant wavelength of the inspection light source of the inspection apparatus of the present invention is smaller than the dominant wavelength of the light-emitting device, the light-emitting device is photoexcited by the inspection light source and an optical property of the light-emitting device is obtained. Accordingly, the inspection apparatus of the present invention gets an optical property of the light-emitting device by a non-destructive method, and the structure of the light-emitting device won't cause any damage, and a reliability of products may be increased. Furthermore, since the inspection light source of the present invention is disposed on the working machine, the inspection light source can carry out a real-time inspection of the light-emitting device while the working machine is working. Therefore, the inspection apparatus of the present invention not only has an advantage of simple and time saving inspection method, but also has an advantage of increasing the reliability of products.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view depicting an inspection apparatus according to one embodiment of the present invention.

FIG. 2A is a schematic view depicting an inspection apparatus according to another embodiment of the present invention.

FIG. 2B is a schematic view depicting an inspection apparatus according to another embodiment of the present invention.

FIG. 3 is a schematic view depicting an inspection apparatus according to another embodiment of the present invention.

FIG. 4 is a schematic view depicting an inspection apparatus according to another embodiment of the present invention.

### DESCRIPTION OF THE EMBODIMENTS

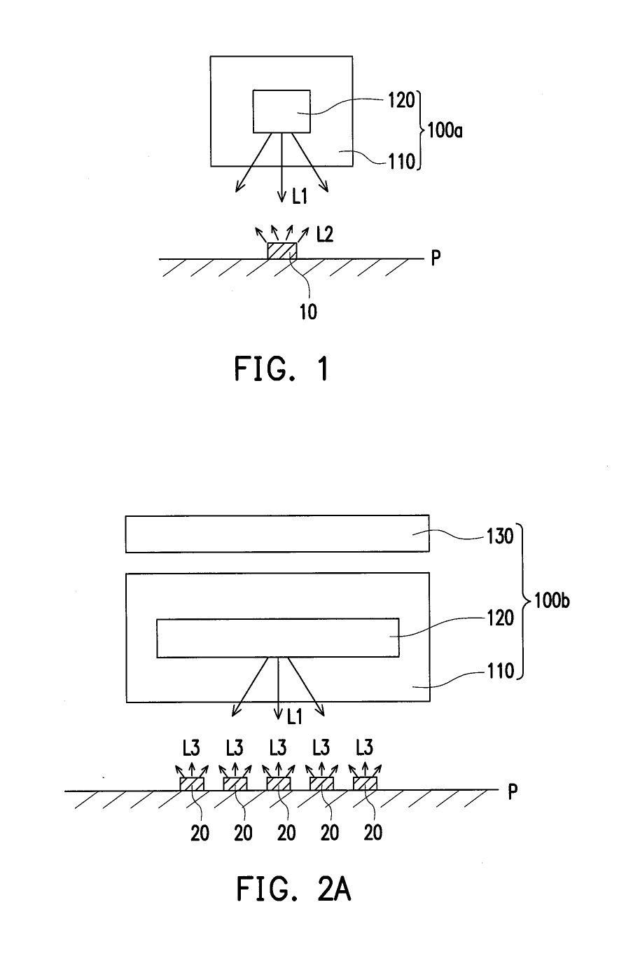

FIG. 1 is a schematic view depicting an inspection apparatus according to one embodiment of the present invention. Referring to FIG. 1, in the present embodiment, an inspection apparatus 100a is capable of inspecting at least one light-emitting device 10. In FIG. 1, one light-emitting device 10 is schematically illustrated. The inspection apparatus 100a includes a working machine 110 and an inspection light source 120. The inspection light source 120 is disposed on the working machine 110 and located above the light-emitting device 10. In particular, a dominant wavelength of the inspection light source 120 is smaller than a dominant wavelength of the light-emitting device 10 so as to excite the light-emitting device 10 and get an optical property of the light-emitting device 10.

In detail, in the present embodiment, the light-emitting device 10 is a LED chip, such as a red LED chip, a blue LED chip or a green LED chip, but the present invention is not limited thereto. The working machine 110 includes a laser cutting machine, a point measurement machine, an auto optic inspection (AOI), a counter or a sorter. The inspection light source 120 is disposed on the working machine 110. That is, the inspection light source 120 and the working machine 110 belong to the same work station.

As depicted in FIG. 1, a projection area of the inspection light source 120 on a horizontal projection plane P overlaps a projection area of the light-emitting device 10 on the horizontal projection plane P, and therefore the light-emitting device 10 can be totally ensured and excited by the inspection light source 120, and the optical property of the light-emitting device 10 is obtained. Herein, the optical property includes a light intensity property and a luminous flux property. Preferably, a dominant wavelength of the inspection light source 120 is between 320 nm and 400 nm, and a difference between the dominant wavelength of the inspection light source 120 and the dominant wavelength of the light-emitting device 10 is at least greater than or equal to 20 nm.

For example, the working machine 110 is a laser cutter, and the light-emitting device 10 is a blue LED chip. After the working machine 110 cutting a wafer (not illustrated) and to form at least one light-emitting device 10, the inspection light source 120 can emit a inspection light L1 (the dominant wavelength thereof is 380 nm) to photoexcited the light-emitting device 10 (the dominant wavelength thereof is 450 nm) so as to emit a excited light L2 and get the optical property of the light-emitting device 10. The optical property may compare with a standard property of the light-emitting device 10. For example, the intensity of the luminous flux or the intensity of light is compared through human eyes so as to sort out the light-emitting device 10 that doesn't meet the standard.

It should be noted that the inspection principle of the present application is that, generally speaking, when an epitaxial layer receives an emitted light having energy greater than an energy level of the material, electrons in a stable sate may be transited to an excited state. When the electrons return to the stable state from the excited state, the energy is released in the form of light, namely photoluminescence. However, if there is a parallel circuit generated or the epitaxial layer is defective, some of the electrons may not be able to return to the stable state. At this time, the luminous flux or light intensity generated may decrease. Therefore, the user may determine the light-emitting chip that does not meet the standard by observing variation of the optical data. In other word, whether the LED chip 10 is abnormal or not can find out in the laser cutting station, and the abnormal LED chip 10 can be pick out if abnormal, and the rest of the process won't be proceed, and the cost of inspecting products and the time needed for inspecting products may be reduced.

Since the inspection light source 120 of the present embodiment is disposed on the working machine 110, the inspection light source 120 may carry out a real-time inspection of the light-emitting device 10 while the working machine 110 is working. Therefore, the inspection apparatus 100a of the present embodiment not only has an advantage of simple and time saving inspection method, but also has an advantage of increasing the reliability of the products.

On the other side, the inspection light source 120 can also irradiate the light-emitting device 10 before the working machine 110 is working so as to get the first optical property. Then, after the working station 110 is worked, the second irradiation is carried out and the second optical property is obtained. Then, whether the working station 110 is abnormal or not can be learned from comparing the two obtained optical properties.

In addition, since the dominant wavelength of the inspection light source 120 of the inspection apparatus 100a of the present embodiment is smaller than the dominant wavelength of the light-emitting device 10, the inspection light source 120 photoexcites the light-emitting device 10 an optical data of the light-emitting device 10 is obtained. Accordingly, the inspection apparatus 100a of the present embodiment gets an optical property of the light-emitting device 10 by a non-destructive method, and the structure of the light-emitting device 10 won't cause any damage, and the reliability of the products may be increased.

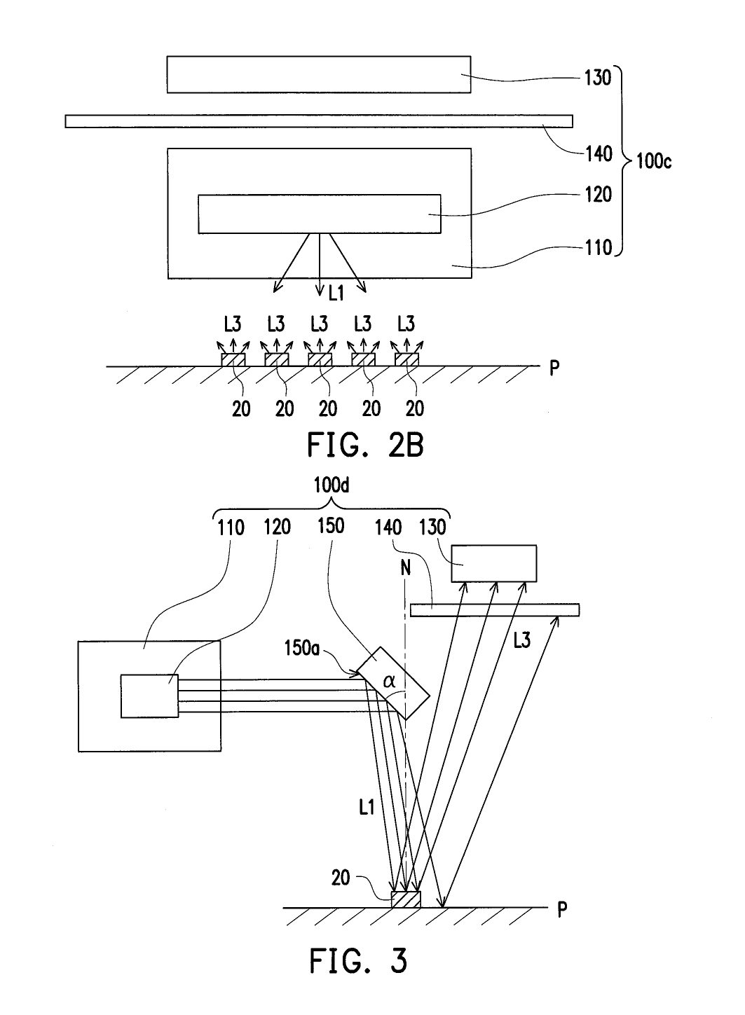

FIG. 2 is a schematic view depicting an inspection apparatus according to another embodiment of the present invention. The present embodiment uses the reference numerals and parts of the contents of the present embodiment aforementioned. Herein, identical notations are used to denote identical or similar elements, and repetitive explanations of the same technical content are omitted. The omitted part can be referred to the above exemplary embodiment and is not repeated hereinafter.

Referring to FIG. 2A, the difference between the inspection apparatus 100b of the present embodiment and the inspection apparatus 100a of the aforementioned embodiment is that the inspection apparatus 100b further includes a light-collecting unit 130. The light-collecting unit 130 is disposed above the inspection light source 120 so as to collect the optical property of the light-emitting devices 20, wherein the light-collecting unit is a charge coupled device (CCD), an integral sphere, a solar panel or a photodetector array. In FIG. 2, a plurality of light-emitting devices 20 are schematically illustrated.

Referring to FIG. 2B, the difference between the inspection apparatus 100c of the present embodiment and the inspection apparatus 100b of the aforementioned embodiment is that the inspection apparatus 100c further includes a filter unit 140. The filter unit 140 is disposed between the light-collecting unit 130 and the inspection light source 120 so as to filter out the inspection light L1 generated by the inspection light source 120. The excited light L3 generated by the light-emitting device 20 is merely allowed to pass through the filter unit 140 and enter into the light-collecting unit 130 so as to reduce the noise of received optical properties. Preferably, the area of the filter unit 140 is greater than the area of the light-collecting unit 130 so as to get a better filter performance.

Since the inspection apparatuses 100b and 100c of the present embodiment may record the optical property of each light-emitting devices 20 by the light-collecting unit 130, and the optical property may be compared with a standard property of the light-emitting device 20 so as to inspect the light-emitting device 20 that doesn't meet the standard. In other words, using quantified numerals to determine the light-emitting device 20 is good or bad can reduce errors and increase the reliability of the products.

Referring to FIG. 3, the difference between the inspection apparatus 100d of the present embodiment and the inspection apparatus 100c of the aforementioned embodiment is that the inspection apparatus 100d further includes a reflecting unit 150, wherein the reflecting unit 150 has a reflective surface 150a. The reflecting unit 150 and the inspection light source 120 are located on proximate horizontal position, and the reflective surface 150a faces the inspection light source 120, wherein the reflective surface 150a reflects the inspection light L1 generated by the inspection light source 120 so as to make the inspection light L1 emit into the light-emitting device 20.

In the inspection apparatus 100d of the present embodiment, the reflective surface 150a is a plane surface, and the reflective surface 150a and a normal line N of the light-emitting unit 20 form an angle α, wherein the angle α may be adjusted according to the incident angle of the inspection light source 120, and the arrangement of the inspection light source 120 and the light-collecting unit 130 can be more flexible on the working machine 110. Preferably, the angle α is between 30 degrees and 60 degrees, and, in this angle range, the reflected inspection light L1 may effectively irradiate the light-emitting device 20.

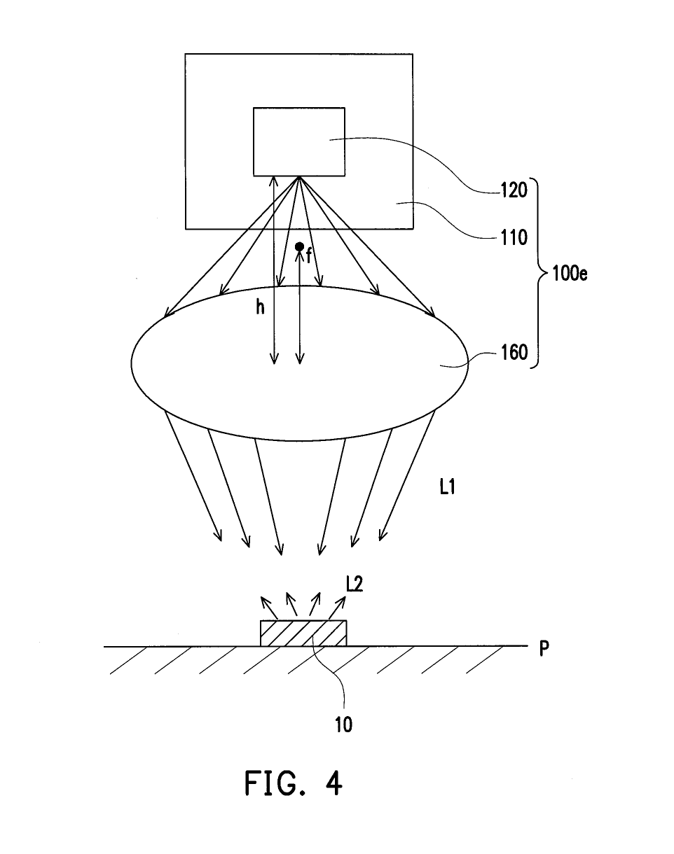

Referring to FIG. 4, the difference between the inspection apparatus 100e of the present embodiment and the inspection apparatus 100a of the aforementioned embodiment is that the inspection apparatus 100e further includes a focusing unit 160, wherein the focusing unit 160 is disposed between the inspection light source 120 and the light-emitting device 10 so as to focus the light generated by the inspection light source 120 and focus the inspection light L1 on the light-emitting device 10 for exciting the light-emitting device 10 and obtaining effective optical properties. In the present embodiment, the focusing unit 160 is specifically a lens, and the minimal vertical distance h between the inspection light source 120 and the focusing unit 160 is greater than or equal to the focal length f of the focusing unit 160. Preferably, the focusing unit 160 is located right below the inspection light source 120, and the area of the focusing unit 160 is greater than the area of the inspection light source 120 so as to more effectively receive the light generated by the inspection light source 120. It should be mentioned that the focusing unit 160 may also be a focusing film or any other devices that can focus light, which is not limited to the abovementioned.

In view of the above, since the dominant wavelength of the inspection light source of the inspection apparatus of the present invention is smaller than the dominant wavelength of the light-emitting device, the light-emitting device is photoexcited by the inspection light source and an optical property of the light-emitting device is obtained. Accordingly, the inspection apparatus of the present invention gets an optical property of the light-emitting device by a non-destructive method, and the structure of the light-emitting device won't cause any damage, and the reliability of the product may be increased. Furthermore, since the inspection light source of the present invention is disposed on the working machine, the inspection light source may carry out a real-time inspection of the light-emitting device while the working machine is working. Therefore, the inspection apparatus of the present invention not only has an advantage of simple and time saving inspection method, but also has an advantage of increasing the reliability of the products.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inspection apparatus, capable of inspecting at least one light-emitting device, the inspection apparatus comprising:
a working machine; and
an inspection light source, disposed on the working machine and located above the light-emitting device, wherein a dominant wavelength of the inspection light source is smaller than a dominant wavelength of the light-emitting device so as to excite the light-emitting device and get an optical property of the light-emitting device.

2. The inspection apparatus as recited in claim 1, wherein the working machine comprises a laser cutting machine, a point measurement machine, an auto optic inspection (AOI), a counter or a sorter.

3. The inspection apparatus as recited in claim 1, wherein the optical property comprises an intensity property and a luminous flux property.

4. The inspection apparatus as recited in claim 1, further comprising:
a light-collecting unit, disposed above the light-emitting device so as to collect the optical property of the light-emitting device.

5. The inspection apparatus as recited in claim 4, wherein the light-collecting unit comprises a charge coupled device (CCD), an integral sphere, a solar panel or a photodetector array.

6. The inspection apparatus as recited in claim 4, further comprising:
a filter unit, disposed between the light-collecting unit and the inspection light source so as to filter out the light generated by the inspection light source.

7. The inspection apparatus as recited in claim 6, further comprising:
a reflecting unit, located on proximate horizontal position with the inspection light source and having a reflective surface, wherein the reflective surface faces the inspection light source and reflects the light generated by the inspection light source so as to make the light generated by the inspection light source emit into the light-emitting device.

8. The inspection apparatus as recited in claim 7, wherein the reflective surface and a normal line of the light-emitting device form an angle and the angle is between 30 degrees and 60 degrees.

9. The inspection apparatus as recited in claim 1, wherein a difference between the dominant wavelength of the inspection light source and the dominant wavelength of the light-emitting device is at least greater than or equal to 20 nanometers.

10. The inspection apparatus as recited in claim 1, wherein the dominant wavelength of the inspection light source ranges between 320 nanometers and 400 nanometers.

11. The inspection apparatus as recited in claim 1, wherein a projection area of the light generated by the inspection light source on a horizontal projection plane overlaps a projection area of the light-emitting device on the horizontal projection plane.

12. The inspection apparatus as recited in claim 1, wherein the light-emitting device comprises at least one light-emitting diode chip.

13. The inspection apparatus as recited in claim 1, further comprising:
a focusing unit, disposed between the inspection light source and the light-emitting device so as to focus the light generated by the inspection light source.

14. The inspection apparatus as recited in claim 13, wherein a minimal vertical distance between the inspection light source and the focusing unit is greater than or equal to a focal length of the focusing unit
